(19) United States
(12) Patent Application Publication
(10) Pub. No.: US 2020/0019023 A1
(43) Pub. Date: Jan. 16, 2020

(54) METHOD OF PRODUCING ARRAY SUBSTRATE INCLUDING ALIGNMENT FILM AND METHOD OF PRODUCING LIQUID CRYSTAL PANEL

(71) Applicant: Sharp Kabushiki Kaisha, Sakai City (JP)

(72) Inventor: Kohshiroh TANIIKE, Sakai City (JP)

(21) Appl. No.: 16/507,086

(22) Filed: Jul. 10, 2019

Related U.S. Application Data
(60) Provisional application No. 62/822,197, filed on Mar. 22, 2019.
(60) Provisional application No. 62/696,865, filed on Jul. 12, 2018.

(51) Int. Cl. G02F 1/1337

(52) U.S. Cl. CPC G02F 1/133784; G02F 1/133723

(57) ABSTRACT

A method of producing an array substrate including an alignment film includes a thin film transistor forming process, a pixel electrode forming process, an alignment film forming process of forming an alignment film to cover the thin film transistor and the pixel electrode formed on the substrate, and a rubbing process of rubbing the alignment film sequentially with a first rubbing roller and a second rubbing roller that have a columnar shape having a rotation shaft parallel to the substrate. First rubbing material on an outer periphery of the first rubbing roller has relatively higher bounce and resilience than those of second rubbing material on an outer periphery of the second rubbing roller, and the first rubbing roller and the second rubbing roller are rotated in a direction so as to push out the substrate in a relatively forwarding direction of the substrate.

### CROSS REFERENCE TO RELATED APPLICATION

This application claims priority from U.S. Provisional Application No. 62/696,865 filed on Jul. 12, 2018 and U.S. Provisional Application No. 62/822,197 filed on Mar. 22, 2019. The entire contents of the priority applications are incorporated herein by reference.

### TECHNICAL FIELD

The technology described herein relates to a method of producing an array substrate including an alignment film and a method of producing a liquid crystal panel.

### BACKGROUND

In a liquid crystal panel, a rubbing treatment of rubbing a surface of the polyimide alignment film disposed on the substrate with a cloth has been widely known as one of the methods of aligning liquid crystals regularly between a pair of substrates. Specifically, there has been widely known a technology of performing the rubbing treatment by rotating a roller having a rubbing cloth on a surface thereof and relatively moving the roller and the substrate having the alignment film thereon.

Horizontal alignment driving modes providing good wide-view angle characteristics such as an IPS mode or a FFS mode have been widely proposed recently. The uneven shape of the substrate is getting more complicated and it is difficult to perform an even alignment treatment with the conventional rubbing method.

Particularly, on the array substrate of the pair of substrates, thin film transistors (TFTs) and pixel electrodes are formed and the rubbing cloth does not surely reach an entire area of the uneven surface due to the complicated uneven shape. Therefore, in the obtained liquid crystal panel, it is difficult to obtain an effective alignment regulation force that can keep an initial alignment state of the liquid crystals that are held between the substrates. The pixel electrodes are formed on the array substrate unlike a CF substrate that is another one of the pair of substrates, and therefore, the alignment regulation force is particularly important for the array substrate. If the rubbing treatment is performed with a great pressing amount to perform the alignment treatment effectively, an amount of foreign obstacles such as shavings of the alignment film or pile waste is increased. Further, alignment disorder or linear unevenness may be caused by pattern transfer of the array substrate. The amount increase of foreign obstacles, the alignment disorder, and occurrence of the linear unevenness may decrease the yield.

### SUMMARY

The technology described in this specification was made in view of the above circumstances. An object is to provide a method of producing an array substrate including an alignment film and having a complicated uneven shape while achieving a high alignment regulation force and high yield. Another technology described in this specification relates to a method of producing a liquid crystal panel that uses the array substrate produced with the above method of producing the array substrate including an alignment film while achieving a high alignment regulation force and high yield.

The technology disclosed in the present specification is related to a method of producing an array substrate including an alignment film including a thin film transistor forming process of forming a thin film transistor on a substrate, a pixel electrode forming process of forming a pixel electrode on the substrate, an alignment film forming process of forming an alignment film to cover the thin film transistor and the pixel electrode formed on the substrate, and a rubbing process of rubbing the alignment film sequentially with a first rubbing roller and a second rubbing roller that have a columnar shape having a rotation shaft parallel to the substrate. The first rubbing roller includes first rubbing material on an outer periphery thereof and the second rubbing roller includes second rubbing material on an outer periphery thereof and the first rubbing material has relatively higher bounce and resilience than those of the second rubbing material, and the first rubbing roller and the second rubbing roller are rotated in a direction so as to push out the substrate in a relatively forwarding direction of the substrate.

According to the above configuration, the substrate including the thin film transistor, the pixel electrode, and the alignment film covering them is subjected to the rubbing treatment with the first rubbing roller that has the first rubbing material of relatively high bounce and resilience on an outer periphery thereof to create an effective alignment regulation force that is required for the alignment in a large area. Subsequently, the rubbing treatment is performed by the second rubbing roller that has the second rubbing material of relatively low bounce and resilience on an outer periphery thereof. Accordingly, the second rubbing material reaches surely an entire area of the complicated uneven surface that has not been rubbed by the first rubbing roller to perform the rubbing treatment in addition to an area that has been subjected to the rubbing treatment with the first rubbing roller. Further, at the same time, the foreign obstacles created by the rubbing treatment of the first rubbing roller can be removed by the second rubbing roller. Therefore, a good alignment regulation force that is uniform over an entire area of the array substrate can be obtained and this increases the yield.

At this time, the rotation direction of the first rubbing roller and the second rubbing roller is set such that the substrate is pushed out in a relatively forwarding direction of the substrate. Accordingly, higher alignment regulation force is obtained since the synergistic effect is obtained and the alignment treatment effect is improved in comparison to the case that the rotation directions of the pair of rubbing rollers are opposite.

According to the method of producing an array substrate including an alignment film and a method of producing a liquid crystal panel described in this specification, a high alignment regulation force and high yield are achieved.

### BRIEF DESCRIPTION OF THE DRAWINGS

FIG. 1 is a schematic view illustrating a method of producing an array substrate including an alignment film according to one embodiment.

FIG. 2 is a schematic cross-sectional view illustrating a cross-sectional configuration of a liquid crystal panel.

FIG. 3 is a plan view schematically illustrating a wiring structure on the array substrate.

### DETAILED DESCRIPTION

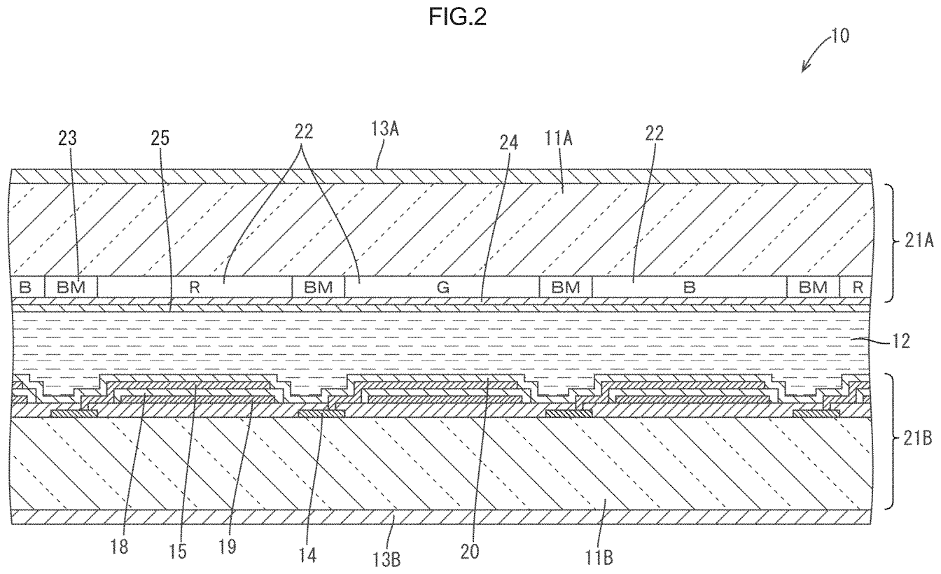

One embodiment will be described. An array substrate 21B including an alignment film that is formed with the producing method of the present embodiment is one of a pair of substrates included in a liquid crystal panel 10 having a known structure illustrated in FIG. 2. The array substrate 21B including the alignment film corresponds to an array substrate 11B including an alignment film 20 thereon that has been subjected to a rubbing treatment.

First, a liquid crystal panel 10 will be described. As illustrated in FIG. 2, the liquid crystal panel 10 includes a pair of substrates 11A, 11B and a liquid crystal layer (one example of liquid crystals) 12 that contains liquid crystal molecules and is arranged in an inner space between the substrates 11A, 11B. The liquid crystal molecules are substances that change optical properties thereof according to application of an electric filed (having dielectric anisotropy and orientation of the liquid crystal molecules are changed according to the application of an electric field). The liquid crystal layer 12 is surrounded by a sealing section that is between the substrates 11A, 11B and sealed therewith. OF the pair of the substrates 11A, 11B, the front side is a CF substrate (one example of a counter substrate) 11A and the back side is an array substrate 11B. Each of the CF substrate 11A and the array substrate 11B is formed by stacking various kinds of films on an inner surface side of a glass substrate. Polarizing plates 13A, 13B are bonded on outer surfaces of the substrates 11A, 11B, respectively.

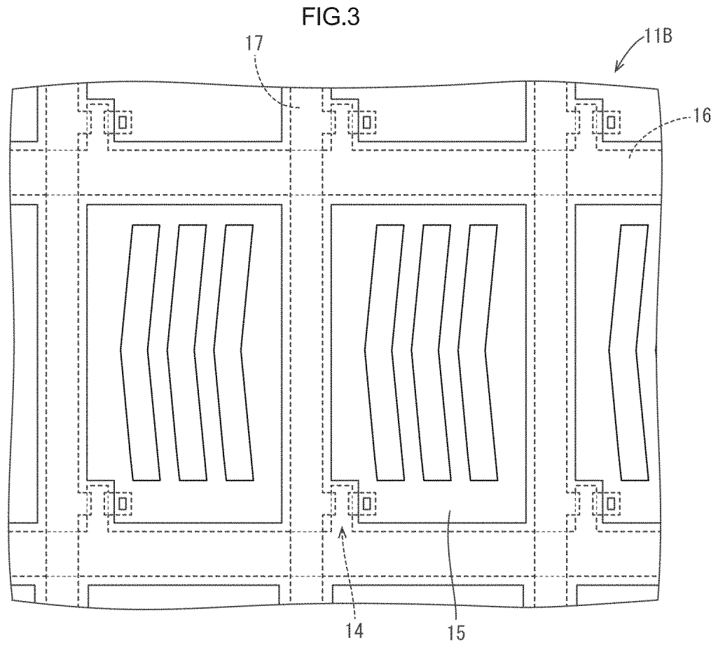

As illustrated in FIGS. 2 and 3, on the array substrate 11B, thin film transistors (TFTs) 14 that are switching components and pixel electrodes 15 are arranged in a matrix and gate lines 16 and source lines 17 are arranged in a grid to surround the TFTs 14 and the pixel electrodes 15. Predetermined image signals are supplied from a control circuit to each of the lines. The pixel electrodes 15 are formed from transparent electrode material such as indium tin oxide (ITO), zinc oxide (ZnO), indium zinc oxide (IZO), or indium gallium zinc oxide (IGZO). The pixel electrodes 15 create a level difference of about 30 nm to 80 nm on the array substrate 11B.

A common electrode 19 that is formed from the transparent electrode film similarly to the pixel electrodes 15 is disposed below the pixel electrode 15 while having an insulation layer 18 therebetween. Thus, the pixel electrode 15 and the common electrode 19 are formed on the array substrate 11B. If a potential difference is created between the electrodes 15, 19, a fringe electric field including a component in a direction normal to a plate surface of the array substrate 11B is applied to the liquid crystal layer 12 in addition to a component in a direction along the plate surface of the array substrate 11B. The liquid crystal panel 10 operates in fringe field switching (FFS) mode that is a mode improved from an in-plane switching (IPS) mode.

An alignment film 20 such as a polyimide film is disposed on an upper surface of the array substrate 11B to cover the TFTs 14 and the pixel electrodes 15.

As illustrated in FIG. 2, the CF substrate 11A includes color filters 22 so as to be opposite the respective pixel electrodes 15 included in the array substrate 11B. The color filters 22 include color portions in three colors of red (R), green (G), and blue (B) arranged repeatedly in a matrix. Each of the color portions (each pixel) of the color filters arranged in a matrix is defined by a light blocking section (a black matrix) 23 and the light blocking section 23 prevents color light rays passing through the color portions from being mixed. An overcoat film 24 is disposed on inner surfaces of the color filters 22 and the light blocking section 23. Columnar photo spacers (PS) are arranged on the light blocking section at a certain density and at certain intervals to keep a gap between the array substrate 11B and the overcoat film 24 for holding the liquid crystal layer 12 therebetween. An alignment film (one example of a counter substrate side alignment film) 25 is disposed on an inner surface of the overcoat film 24.

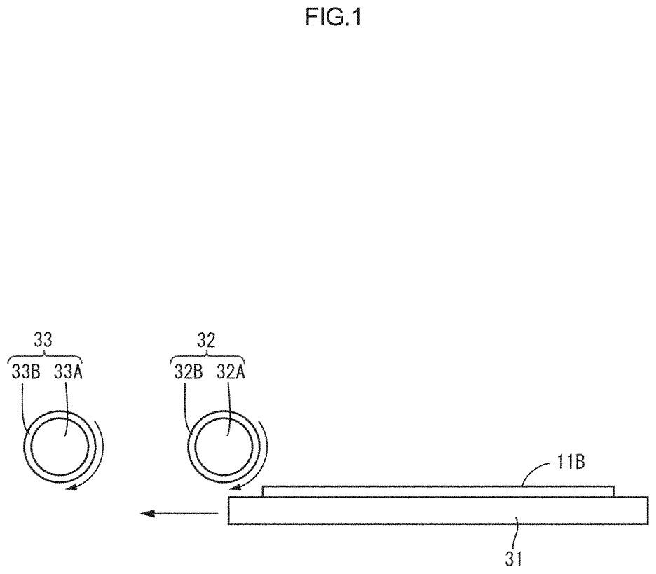

Next, a method of producing an array substrate 21B including an alignment film will be described. FIG. 1 is a schematic view illustrating an alignment treatment method (a rubbing process) for the array substrate 11B having the alignment film 20 thereon according to one embodiment. First, the thin film transistors (TFTs) 14 and the pixel electrodes 15 are formed on the substrate (a thin film transistor forming process and a pixel electrode forming process) and the alignment film 20 is formed to cover the TFTs 14 and the pixel electrodes 15 (an alignment film forming process). The array substrate 11B having the alignment film 20 thereon is held with being sucked on a stage 31 of a transfer device included in a rubbing device in a horizontal state. The feeding speed (stage moving speed) of the stage 31 can be changed, and the rotational speed of rubbing rollers 32, 33, which will be described later, and the number of rubbing times of rubbing the alignment film 20 can be adjusted.

The rubbing device includes a pair of rotatable rubbing rollers 32, 33 above a transfer path of the stage 31. One of the rubbing rollers 32, 33 is a first rubbing roller 32 disposed on an upstream side in the transfer direction and another one is a second rubbing roller 33 disposed on a downstream side in the transfer direction from the first rubbing roller 32.

The first rubbing roller 32 and the second rubbing roller 33 have a columnar shape and a rotation shaft thereof is parallel to the array substrate 11B and perpendicular to the transfer direction. The first rubbing roller 32 and the second rubbing roller 33 have a same length and a same diameter.

The first rubbing roller 32 includes a first roller 32A having a columnar shape and a cloth (one example of first rubbing material) 32B made of cotton. An outer surface of the first roller 32A is wrapped with the cloth 32B. The second rubbing roller 33 includes a second roller 33A having a columnar shape and a cloth (one example of second rubbing material) 33B made of rayon. An outer surface of the second roller 33A is wrapped with the cloth 33B. Accordingly, the surface of the first rubbing roller 32 has higher bounce and resilience than the surface of the second rubbing roller 33.

The rubbing material 32B, 33B of the first rubbing roller 32 and the second rubbing roller 33 may not be limited to cotton and rayon but may be desired rubbing material. The rotation direction, the rotational speed, and a level position with respect to the array substrate 11B (the stage 31) may be determined independently for each of the first rubbing roller 32 and the second rubbing roller 33. The rotational speed is defined by the number of rotation times of the rubbing roller 32, 33 per unit time (rpm/revolutions per minute). The position level of the rubbing rollers 32, 33 adjusts a pressing amount (a contact amount) by which the rubbing material 32B, 33B of each of the rubbing rollers 32, 33 is contacted with the array substrate 11B. Furthermore, the position level of the rubbing rollers 32, 33 can be set such that one of the rubbing rollers 32, 33 is contacted with the array substrate 11B and another one is away from the array substrate 11B and one of the rubbing materials 32B, 33B wrapped around the rollers is not contacted with the array substrate 11B.

If the array substrate 11B including the alignment film 20 on the surface thereof is transferred in the transfer direction by the transfer device, the first rubbing roller 32 and the second rubbing roller 33 are rotated and in contact with the surface of the alignment film 20 sequentially and the rubbing treatment is performed (the rubbing process). In the process, the first rubbing roller 32 and the second rubbing roller 33 are rotated in a direction so as to push out the array substrate 11 (rotated in a clockwise direction in FIG. 1) (hereinafter, the rubbing treatment by the rotation in the direction is referred to as down rubbing and the rubbing treatment by the rotation so as to push back the array substrate 11B is referred to as upper rubbing as will be described later).

The rubbing treatment is performed by the first rubbing roller 32 that has relatively high bounce and resilience in the surface to create an effective alignment regulation force that is required for the alignment in a large area, and subsequently, the rubbing treatment is performed by the second rubbing roller 33 that has relatively low bounce and resilience in the surface to perform the rubbing treatment surely over an entire area of the complicated uneven surface that has not been rubbed by the first rubbing roller 32 and create the effective alignment regulation force. Further, at the same time, the foreign obstacles created by the rubbing treatment of the first rubbing roller 32 can be removed by the second rubbing roller 33 having low bounce and resilience in the surface. Therefore, a good alignment regulation force that is uniform over an entire area of the array substrate 11B can be obtained and this increases the yield.

The rotation direction of the first rubbing roller 32 and the second rubbing roller 33 is a direction of the down rubbing such that the synergistic effect can be obtained in the alignment treatment and a higher alignment regulation force can be obtained.

The present embodiment is characterized in that not only the pressing amount (the contact amount) of the rubbing roller 32, 33 with respect to the substrate is changed but also a kind of the first rubbing material 32B and the second rubbing material 33B is changed to change rubbing power from high to low by using a degree of bounce and resilience of the rubbing material itself. The change of the rubbing power by changing the pressing amount is limited due to various reasons such as folding of fibers of the rubbing material, generation of dust from the rubbing material, and linear unevenness, and an effective alignment regulation force is not obtained while satisfying the above demands in the conventional art. The array substrate 21B including the alignment film with a good alignment regulation force (high retardation of the alignment film) can be obtained by using the bounce and resilience of the rubbing material itself without losing other properties (without occurring large amount of foreign obstacles or linear unevenness) as is in the present embodiment.

After the rubbing process, the liquid crystals (the liquid crystal layer 12) are sealed between the obtained array substrate 21B including the alignment film and the CF substrate 21A including the alignment film and sealed with sealing material. The CF substrate 21A including the alignment film is arranged opposite the array substrate 21B including the alignment film on the alignment film 20 side and includes an alignment film 25 (one example of a counter substrate side alignment film) on a surface thereof opposite the array substrate 21B including the alignment film. Thus, the liquid crystal panel 10 including the liquid crystals (the liquid crystal layer 12) between the pair of substrates 21A, 21B is produced (a liquid crystals holding process).

The CF substrate 21A including the alignment film is obtained by performing the rubbing treatment with using the first rubbing roller 32 and the second rubbing roller 33 similarly to the array substrate 21B including the alignment film. However, the rotation direction of the rollers is different such that the first rubbing roller 32 is rotated with the upper rubbing and the second rubbing roller 33 is rotated with the down rubbing.

The liquid crystal panel 10 produced as described above has a good alignment regulation force without having unevenness and has high yield.

Next, Examples in which the producing method of the embodiment is specifically carried out and Comparative Examples will be described in detail.

1. Verification of an array substrate including an alignment film and a dummy substrate including an alignment film that are subjected to a rubbing treatment with using a single rubbing roller

Prior to Examples, the array substrate including an alignment film and the dummy substrate including an alignment film that are subjected to the rubbing treatment with using a single rubbing roller were evaluated with a method described below.

First, the array substrate 11B on which the thin film transistors (TFTs) 14 and the pixel electrodes 15 are formed (the thin film transistor forming process and the pixel electrode forming process) and the dummy substrate without having such patterns were obtained. On each of the array substrate 11B and the dummy substrate, a polyimide film having film thickness of about 100 nm was formed with flexographic printing method (the alignment film forming process). Each of the substrates including films was placed on the stage 31 of the transfer device at a certain position and held with being sucked. Then, the array substrate including a film and the dummy substrate including a film were transferred at a speed of 20 mm/sec and subjected to the rubbing treatment by a single rubbing roller including a roller of a 150 mm ϕ diameter and rubbing material wrapped around the roller under the conditions illustrated in Table 1.

Thereafter, for each array substrate including the alignment film, frequencies of generation of dust and occurrence of unevenness were observed. The frequency of generation of dust was observed by counting the number of foreign obstacles on the array substrate including the alignment film with using a foreign obstacle checker produced by KUBOTECH Corp. The frequency of occurrence of unevenness was observed by supplying steam to the alignment treatment surface of the array substrate including the alignment film and visually checking the unevenness with using a halogen lamp and a green lamp.

The retardation (Δnd) that is an index of the alignment regulation force was measured for each of the dummy substrates including alignment films. “AxoScan FAA-3 series” produced by Axometrics, Inc. was used for the measurement. Light is supplied to the alignment processed surface of the dummy substrate including an alignment film from an upper side thereof and the retardation of transmitted light rays was measured. The retardation was measured at twelve points within the alignment film surface area and average, standard deviation, and standard deviation/average were calculated. The retardation of the dummy substrate including an alignment film is measured since the light rays for measurement may be reflected irregularly by the uneven pattern such as the TFTs 14 or the pixel electrodes 15 and correct measurement values of the alignment film may not be obtained if the measurement is performed for the array substrate including an alignment film.

The production conditions and the measurement results of each sample are illustrated in Table 1.

TABLE 1

| | | | ROTATIONAL | CONTACT |
|---|---|---|---|---|
| | RUBBING | ROTATION | SPEED | AMOUNT |
| | CLOTH | DIRECTION | [rpm] | [mm] |
| COMPARATIVE EXAMPLE 1 | COTTON | UPPER | 1000 | 0.3 |
| COMPARATIVE EXAMPLE 2 | COTTON | UPPER | 1000 | 0.5 |
| COMPARATIVE EXAMPLE 3 | COTTON | DOWN | 1000 | 0.5 |
| COMPARATIVE EXAMPLE 4 | COTTON | DOWN | 1000 | 0.6 |
| COMPARATIVE EXAMPLE 5 | COTTON | DOWN | 1000 | 0.7 |
| COMPARATIVE EXAMPLE 6 | COTTON | DOWN | 1200 | 0.5 |
| COMPARATIVE EXAMPLE 7 | RAYON | DOWN | 1200 | 0.4 |
| COMPARATIVE EXAMPLE 8 | RAYON | DOWN | 1200 | 0.5 |

| | RETARDATION [Δnd] | | | |
|---|---|---|---|---|
| | | STANDARD | STANDARD DEVIATION/ | DUST AND |
| | AVERAGE | DEVIATION | AVERAGE | UNEVENNESS |
| COMPARATIVE EXAMPLE 1 | 0.2162 | 0.0334 | 15% | Δ |
| COMPARATIVE EXAMPLE 2 | 0.2765 | 0.1317 | 48% | Δ |
| COMPARATIVE EXAMPLE 3 | 0.2932 | 0.0763 | 26% | ◯ |
| COMPARATIVE EXAMPLE 4 | 0.3526 | 0.0899 | 26% | ◯ |
| COMPARATIVE EXAMPLE 5 | 0.4304 | 0.1036 | 24% | ◯ |
| COMPARATIVE EXAMPLE 6 | 0.2998 | 0.0599 | 20% | ◯ |
| COMPARATIVE EXAMPLE 7 | 0.2237 | 0.0261 | 12% | ⊚ |
| COMPARATIVE EXAMPLE 8 | 0.2599 | 0.0626 | 24% | ⊚ |

⊚ QUITE LESS
◯ LESS
Δ A FEW

As illustrated in Table 1, in comparing Comparative Example 1 and Comparative Example 2 in which cotton was used as the rubbing material and the upper rubbing was performed at the rotational speed of 1000 rpm, the average of the retardation is better in Comparative Example 2 in which the contact amount is great (the pressing amount is great) than Comparative Example 1 in which the contact amount is small; however, variation of the retardation (standard deviation/average) was 48% that is almost twice of the value of other Comparative Examples and it was found that uniform rubbing effect (the alignment regulation force) is hardly obtained in Comparative Example 2.

According to Comparative Example 2 and Comparative Example 3 in which the rotation direction of the rubbing roller is changed to the down rubbing from Comparative Example 2, it was found that the higher retardation (the average) was obtained and variation (standard deviation/average) was reduced in the down rubbing. The down rubbing causes less generation of dust and less occurrence of unevenness and improves the yield.

According to Comparative Example 3 and Comparative Examples 4 and 5 in which the contact amount is increased from that of comparative Example 3, it was confirmed that the retardation (the average) was better with the greater contact amount and variation was almost same in the down rubbing.

Furthermore, according to Comparative Example 3 and Comparative Example 6 in which the rotational speed is increased to 1200 rpm from that of Comparative Example 3, it was confirmed that the variation of the retardation was slightly improved at the higher rotational speed. The average of the retardation, the generation of dust, and occurrence of unevenness were almost same.

In comparing Comparative Example 7 and Comparative Example 8 in which rayon having relatively lower bounce and resilience was used as the rubbing material and the down rubbing was performed at the rotational speed of 1200 rpm, the retardation was slightly smaller in Comparative Example 7 with the smaller contact amount and the variation was a half of that in Comparative Example 8. It was found that uniform rubbing effect (the alignment regulation force) was obtained in Comparative Example 7.

The evaluation results regarding the generation of dust and the occurrence of unevenness in the array substrates including alignment films are also illustrated in Table 1. The generation of dust and the occurrence of unevenness are less in the down rubbing than in the upper rubbing and less in rayon than in cotton. Great difference was not observed with the contact amounts in cotton and rayon.

2. Evaluation of an array substrate including an alignment film and a dummy substrate including an alignment film that are subjected to a rubbing treatment with using two rubbing rollers

Based on the results of the rubbing treatment with using a single rubbing roller illustrated in Table 1, the evaluation was made for the array substrate 21B including an alignment film and the dummy substrate including an alignment film that are subjected to the rubbing treatment (the rubbing process) with using the two rubbing rollers 32, 33 under the conditions of Table 2. The method of forming the substrate including a film performed before the rubbing treatment is same as that of above 1, and the transfer speed is 20 mm/sec similarly to the above 1. The measurement method is same as that of the above 1. The production conditions and the measurement results of each sample are illustrated in Table 2.

TABLE 2

| | FIRST RUBBING ROLLER | | | | | |
|---|---|---|---|---|---|---|
| | | | ROTATIONAL | CONTACT | RETARDATION | |
| | RUBBING | ROTATION | SPEED | AMOUNT | AVERAGE | |
| | CLOTH | DIRECTION | [rpm] | [mm] | Δnd1 | |
| COMPARATIVE EXAMPLE 9 | COTTON | UPPER | 1000 | 0.3 | 0.2162 | |
| COMPARATIVE EXAMPLE 10 | COTTON | DOWN | 1000 | 0,7 | 0.4304 | |
| COMPARATIVE EXAMPLE 11 | COTTON | DOWN | 1000 | 0.7 | 0.4304 | |
| EXAMPLE 1 | COTTON | DOWN | 1200 | 0.5 | 0.2998 | |
| EXAMPLE 2 | COTTON | DOWN | 1000 | 0.7 | 0.4304 | |
| COMPARATIVE EXAMPLE 12 | RAYON | DOWN | 1200 | 0.4 | 0.2237 | |
| EXAMPLE 3 | COTTON | DOWN | 1000 | 0.7 | 0.4304 | |
| COMPARATIVE EXAMPLE 13 | RAYON | DOWN | 1200 | 0.5 | 0.2599 | |
| | SECOND RUBBING ROLLER | | | | | |
| | | | ROTATIONAL | CONTACT | RETARDATION | |
| | RUBBING | ROTATION | SPEED | AMOUNT | AVERAGE | |
| | CLOTH | DIRECTION | [rpm] | [mm] | Δnd2 | |
| COMPARATIVE EXAMPLE 9 | COTTON | DOWN | 1000 | 0.5 | 0.2932 | |
| COMPARATIVE EXAMPLE 10 | COTTON | DOWN | 1000 | 0.5 | 0.2932 | |
| COMPARATIVE EXAMPLE 11 | COTTON | DOWN | 1000 | 0.6 | 0.3526 | |
| EXAMPLE 1 | RAYON | DOWN | 1200 | 0.5 | 0.2599 | |
| EXAMPLE 2 | RAYON | DOWN | 1200 | 0.4 | 0.2237 | |
| COMPARATIVE EXAMPLE 12 | COTTON | DOWN | 1000 | 0.7 | 0.4304 | |
| EXAMPLE 3 | RAYON | DOWN | 1200 | 0.5 | 0.2599 | |
| COMPARATIVE EXAMPLE 13 | COTTON | DOWN | 1000 | 0.7 | 0.4304 | |
| | | TWO RUBBING ROLLERS | | | | |
| | | RETARDATION [Δnd] | | | DUST | |
| | | | | STANDARD | AND | |
| | SECOND/ | | STANDARD | DEVIATION/ | UNEVEN- | |
| | FIRST (*) | AVERAGE | DEVIATION | AVERAGE | NESS | α (**) |
| COMPARATIVE EXAMPLE 9 | — | 0.2366 | 0.1136 | 48% | Δ | — |
| COMPARATIVE EXAMPLE 10 | 68% | 0.7097 | 0.2620 | 37% | Δ | −0.01396 |
| COMPARATIVE EXAMPLE 11 | 82% | 0.7589 | 0.2711 | 36% | Δ | −0.02412 |
| EXAMPLE 1 | 87% | 0.5197 | 0.1383 | 27% | ⊚ | −0.04006 |
| EXAMPLE 2 | 52% | 0.7700 | 0.1823 | 24% | ⊚ | 0.11593 |
| COMPARATIVE EXAMPLE 12 | — | 0.4371 | 0.1041 | 24% | — | — |
| EXAMPLE 3 | 60% | 0.7280 | 0.2078 | 29% | ◯ | 0.03769 |
| COMPARATIVE EXAMPLE 13 | — | 0.4308 | 0.1009 | 23% | — | — |

(*) (RETARDATION BY SECOND ROLLER/RETARDATION BY FIRST ROLLER) × 100
(**) α = (RETARDATION BY TWO ROLLERS) − (RETARDATION BY FIRST ROLLER + RETARDATION BY SECOND ROLLER)
⊚ QUITE LESS
◯ LESS
Δ A FEW

As illustrated in Table 2, in Comparative Example 9, the first rubbing material 32B and the second rubbing material 33B are the same material (cotton) and the rotation direction of the first rubbing roller 32 is the upper rubbing and that of the second rubbing roller 33 is the down rubbing. In comparative Example 9, great change was not observed in the measurement values of the retardation compared to the measurement values obtained with using a single rubbing roller because the rubbing effects may be cancelled by the opposite rotation directions of the rubbing rollers. Variation of the retardation was 48% which was greater than other examples.

Next, Comparative Example 10 and Comparative Example 11 will be considered. In Comparative Example 10 and Comparative Example 11, the first rubbing material 32B and the second rubbing material 33B are the same material (cotton) similarly to Comparative Example 9 and a combination of the down rubbing that provides relatively higher retardation than that of the upper rubbing is performed. In the Comparative Examples, the contact amount (the pressing amount) of the first rubbing roller 32 was same (0.7 mm) and the contact amounts of the second rubbing roller 33 are set to different values (0.5 mm and 0.6 mm) that are smaller than that of the first rubbing roller 32. Namely, the rubbing is shifted from high rubbing to low rubbing.

It is found from the results in Table 2 that the retardation (Δnd) (average) by the two rubbing rollers 32, 33 was improved close to the total value (Δnd1+Δnd2) of the retardation by the respective rubbing rollers in combination of the down rubbings. As the difference between the contact amounts of the first rubbing roller 32 and the second rubbing roller 33 is greater, the retardation (Δnd) becomes smaller because the total value itself becomes small. On the other hand, as the difference between the contact amounts of the first rubbing roller 32 and the second rubbing roller 33 is greater, the retardation (Δnd) becomes closer to the total value (Δnd1+Δnd2) of the retardation by the respective rubbing rollers (difference α from the total value becomes smaller). In other words, each retardation by independent rubbing roller is less likely to be lost. The rubbing material originally has variation in length of cloth fibers and long fiber and short fiber exert superior effects, respectively. According to increase of the difference in the contact amounts (the pressing amount), effects obtained by the difference in the pressing amounts of the fibers having different lengths can be exerted in a wide area in addition to the effects obtained by the different fiber lengths.

With reference to the specific values, a ratio of the retardation of the substrate processed by the second rubbing roller 33 to the retardation of the substrate processed by the first rubbing roller 32 (Δnd2/Δnd1×100(%)) is 68% in Comparative Example 10 and 82% in Comparative Example 11. It is found that in Comparative Example 10 in which the ratio is smaller (namely, the difference in the retardation is greater), the retardation (Δnd) by the two rubbing rollers 32, 33 is closer to the total value (Δnd1+Δnd2) of the retardation by the respective rubbing rollers (namely, the difference α becomes smaller). A preferable ratio of the retardations by the two rubbing rollers 32, 33 will be described in detail later.

In Comparative Examples 9 to 11, cotton was used as the first rubbing material 32B and the second rubbing material 33B and a few amount of dust was seen and unevenness was observed.

In Comparative Example 10 and Comparative Example 11, power of rubbing is changed from high to low by changing the contact amount (the pressing amount). In Comparative Example 12 and Comparative Example 13, for example, power of rubbing is changed by changing not only the pressing amount but also a kind of the rubbing material. Specifically, rayon having relatively low bounce and resilience is used as the first rubbing material 32B and cotton having relatively high bounce and resilience is used as the second rubbing material 33B to change the power of rubbing from low to high. Considering the results of Comparative Example 12 and Comparative Example 13, the retardation (Δnd) of the substrate that is subjected to the rubbing treatment with the two rubbing rollers 32, 33 was the retardation that is close to the result (Δnd2) obtained with using only one second rubbing roller 33. Namely, advantageous effect of the first rubbing roller 32 was hardly exerted. Accordingly, it is found that almost no effect was obtained by performing the rubbing treatment twice if the power of rubbing is changed from low to high.

Contrary to Comparative Examples as described before, in Example 1, cotton having relatively high bounce and resilience is used as the first rubbing material 32B, and subsequently, rayon having relatively low bounce and resilience is used as the second rubbing material 33B such that the power of rubbing is changed from high to low by changing the type of rubbing material without changing the contact amount. In Example 1, the retardation (Δnd) close to the total value (Δnd1+Δnd2) of the retardation by the first rubbing roller 32 and the second rubbing roller 33 each of which is used independently was obtained.

Such results are similar to those obtained in Comparative Example 10 and Comparative Example 11; however, the variation (standard deviation/average) was improved in Example 1 compared to Comparative Examples. In Example 1, generation of dust and occurrence of unevenness were improved and the yield was good. Such results may be obtained because rayon was used as the second rubbing material 33B.

Further, in Example 2 and Example 3, the power of rubbing is changed from high to law by changing the contact amount (the pressing amount) from great to small in addition to using cotton as the first rubbing material 32B and using rayon as the second rubbing material 33B similarly to Example 1. In Example 2 and Example 3, the retardation (Δnd) greater than the total value (Δnd1+Δnd2) of the retardation by the respective rubbing rollers was obtained (a was a plus value). Namely, in such Examples, the synergetic effects were obtained regarding the retardation. Further, the variation (standard deviation/average) was less likely to be caused similarly to Example 1.

In Example 2 and Example 3, the contact amount of the first rubbing roller 32 was same (0.7 mm) and the contact amount of the second rubbing roller 33 was varied in different values (0.4 mm and 0.5 mm) that are smaller than that of the first rubbing roller 32. In comparing Example 2 and Example 3, the retardation (Δnd) becomes greater than that of Example 3 in Example 2 where the difference of the contact amounts of the first rubbing roller 32 and the second rubbing roller 33 is great, and difference (+α) between the retardation (Δnd) and the total value (Δnd1+Δnd2) of the retardation by the respective rubbing rollers is greater in Example 2 than that of Example 3. Namely, great synergetic effects are obtained.

Here, a preferable ratio (Δnd2/Δnd1) of the retardations by the first rubbing roller 32 and the second rubbing roller 33 each of which is independently used will be examined. The ratio of the retardation of the substrate processed by the second rubbing roller 33 to the retardation of the substrate processed by the first rubbing roller 32 (Δnd2/Δnd1×100(%)) is 52% in Example 2 and 60% in Example 3. It is found that in Example 2 in which the ratio is smaller (namely, the difference in the retardation is greater), the retardation (Δnd) by the two rubbing rollers 32, 33 is greater compared with Example 3 than the total value (Δnd1+Δnd2) of the retardation by the respective rubbing rollers (namely, the difference α becomes greater). If the difference becomes too large, the retardation (Δnd2) by the second rubbing roller 33 is necessarily decreased. Therefore, if the second rubbing roller 33 is set so as to have a retardation between 50% and 60% of the retardation (Δnd1) by the first rubbing roller 32, the retardation (Δnd) that is equal to or greater than the total value (Δnd1+Δnd2) of the retardation by the respective rubbing rollers can be obtained most effectively.

Further, in Example 2 and Example 3, the generation of dust and the occurrence of unevenness are less compared to Comparative Examples. Such results are obtained because rayon was used as the second rubbing material 33B and the foreign obstacles created in the rubbing treatment by the first rubbing roller 32 are removed by rayon having low bounce and resilience.

According to the results described before, it was confirmed that the rubbing effects are enhanced and good retardation is obtained if the rubbing treatment is performed with cotton having relatively high bounce and resilience and subsequently the rubbing treatment is performed with rayon having relatively low bounce and resilience. The liquid crystal panel 10 that is obtained through such a rubbing process has less generation of dust and less occurrence of unevenness.

### OTHER EMBODIMENTS

The present technology is not limited to the embodiments described in the above sections and the drawings. For example, the following embodiments may be included in the technical scope.

(1) In Example 2 and Example 3, the rotational speed of the first rubbing roller 32 and that of the second rubbing roller 33 are different from each other but may be same.

(2) In the above embodiment, the first rubbing roller 32 and the second rubbing roller 33 have a same diameter but may have different diameters.

(3) In the above embodiment, the rotation shaft of each of the first rubbing roller 32 and the second rubbing roller 33 is orthogonal to the transfer direction but may not be orthogonal to the transfer direction.

(4) In Example 2 and Example 3, the pressing amount (the contact amount) of the first rubbing roller 32 with respect to the substrate is greater than the pressing amount of the second rubbing roller 33 and the rotational speed of the first rubbing roller 32 is lower than the rotational speed of the second rubbing roller 33; however, the pressing amount and the rotational speed may not be necessarily limited to those in Examples and may be altered as appropriate. Namely, the first rubbing roller 32 and the second rubbing roller 33 do not necessarily have the above relation but may be adjusted with a type of the rubbing material such that the rubbing power is higher in the first rubbing roller 32 than the second rubbing roller 33. For example, the pressing amount (the contact amount) of the first rubbing roller 32 and the second rubbing roller 33 may be set to be same as is in Example 1, the pressing amount of the second rubbing roller 33 may be set greater than that of the first rubbing roller 32, the rotational speed of the first rubbing roller 32 and that of the second rubbing roller 33 may be set to be same as is in Example 1, or the rotational speed of the second rubbing roller 33 may be set lower than that of the first rubbing roller 32.

(5) The transfer speed of the transfer device may be altered as appropriate.

1. A method of producing an array substrate including an alignment film comprising:
a thin film transistor forming process of forming a thin film transistor on a substrate;
a pixel electrode forming process of forming a pixel electrode on the substrate;
an alignment film forming process of forming an alignment film to cover the thin film transistor and the pixel electrode formed on the substrate; and
a rubbing process of rubbing the alignment film sequentially with a first rubbing roller and a second rubbing roller that have a columnar shape having a rotation shaft parallel to the substrate, wherein
the first rubbing roller includes first rubbing material on an outer periphery thereof and the second rubbing roller includes second rubbing material on an outer periphery thereof and the first rubbing material has relatively higher bounce and resilience than those of the second rubbing material, and
the first rubbing roller and the second rubbing roller are rotated in a direction so as to push out the substrate in a relatively forwarding direction of the substrate.

2. The method of producing an array substrate including an alignment film according to claim 1, wherein the first rubbing material is cotton and the second rubbing material is rayon.

3. The method of producing an array substrate including an alignment film according to claim 1, wherein in the rubbing process, the first rubbing roller and the second rubbing roller are used in a combination such that retardation (Δnd2) of the substrate that is rubbed by a single roller of the second rubbing roller is in a range from 50% to 60% of retardation (Δnd1) of the substrate that is rubbed by a single roller of the first rubbing roller.

4. The method of producing an array substrate including an alignment film according to claim 1, wherein in the rubbing process, the first rubbing roller has a pressing amount with respect to the substrate that is greater than a pressing amount of the second rubbing roller.

5. A method of producing a liquid crystal panel comprising:
a liquid crystal holding process of holding liquid crystals between the array substrate including an alignment film that is produced with the producing method according claim 1 and a counter substrate including an alignment film that is disposed opposite the alignment film of the array substrate including the alignment film, the counter substrate including an counter substrate side alignment film on a surface thereof opposite the array substrate including the alignment film.
